(19) United States
(12) Patent Application Publication
(10) Pub. No.: US 2013/0172469 A1
(43) Pub. Date: Jul. 4, 2013

(54) Thermoplastic Resin Composition and Molded Product Using the Same

(71) Applicant: CHEIL INDUSTRIES INC., Kumi-city (KR)

(72) Inventors: In-Chol KIM, Uiwang-si (KR); Jin-Uk HA, Uiwang-si (KR); Chang-Min HONG, Uiwang-si (KR)

(73) Assignee: CHEIL INDUSTRIES INC., Kumi-city (KR)

(21) Appl. No.: 13/651,766

(22) Filed: Oct. 15, 2012

(30) Foreign Application Priority Data
Dec. 29, 2011 (KR) 10-2011-0146189

(51) Int. Cl. C08L 51/04; C08L 69/00

(52) U.S. Cl. 524/504; 525/67

(57) ABSTRACT

Disclosed is a thermoplastic resin composition that includes (A) a polycarbonate resin; (B) a graft copolymer including an aromatic vinyl compound and a vinyl cyanide compound grafted on a conjugated diene-based rubbery polymer; and (C) a copolymer of an aromatic vinyl compound and a vinyl cyanide compound, wherein the copolymer (C) of an aromatic vinyl compound and a vinyl cyanide compound includes a repeating unit derived from the vinyl cyanide compound in an amount of about 18 wt % to about 22 wt %, based on the total amount of the copolymer (C). A molded product prepared using the thermoplastic resin composition is also provided.

### CROSS-REFERENCE TO RELATED APPLICATIONS

This application claims priority to and the benefit of Korean Patent Application No. 10-2011-0146189 filed in the Korean Intellectual Property Office on Dec. 29, 2011, the entire disclosure of which is incorporated herein by reference.

### FIELD

A thermoplastic resin composition and a molded product using the same are disclosed.

### BACKGROUND

Recently, reducing the weight of automobiles and other vehicles has drawn attention due to the rapid increase of oil prices, the spread of environmentally-friendly electric vehicles, and the like. Accordingly, there is an increased demand for light weight materials which can be used for plating.

A commonly used plating material for automobiles and other vehicles includes an acrylonitrile-butadiene-styrene (ABS) resin and/or a polycarbonate/acrylonitrile-butadiene-styrene (PC/ABS) resin. For example, a polycarbonate/acrylonitrile-butadiene-styrene (PC/ABS) resin can be used in applications requiring impact resistance.

However, the plating properties of acrylonitrile-butadiene-styrene (ABS) resins and/or the polycarbonate/acrylonitrile-butadiene-styrene (PC/ABS) resins can vary depending on composition and content. Thus, there is a need for a material having a precise composition and content of each component.

### SUMMARY

One embodiment provides a thermoplastic resin composition that can have excellent etching and plating adhesion (close contacting) properties.

Another embodiment provides a molded product using the thermoplastic resin composition.

According to one embodiment, provided is a thermoplastic resin composition that includes (A) a polycarbonate resin; (B) a graft copolymer including an aromatic vinyl compound and a vinyl cyanide compound grafted on a conjugated diene-based rubbery polymer; and (C) a copolymer of an aromatic vinyl compound and a vinyl cyanide compound. The copolymer (C) of an aromatic vinyl compound and a vinyl cyanide compound includes a repeating unit derived from the vinyl cyanide compound in an amount of about 18 wt % to about 22 wt %, based on the total amount (weight) of the copolymer (C).

The polycarbonate resin (A) may have a weight average molecular weight (Mw) of about 10,000 g/mol to about 50,000 g/mol.

The conjugated diene-based rubbery polymer may include a butadiene rubbery polymer, an isoprene rubbery polymer, a chloroisoprene rubbery polymer, or a combination thereof.

The aromatic vinyl compound may include styrene, C₁ to C₁₀ alkyl substituted styrene, halogen substituted styrene, vinyl toluene, vinyl naphthalene, or a combination thereof.

The vinyl cyanide compound may include acrylonitrile, methylacrylonitrile, ethylacrylonitrile, or a combination thereof.

The graft copolymer (B) may include a core including the conjugated diene-based rubbery polymer and a shell including a repeating unit derived from the aromatic vinyl compound and a repeating unit derived from the vinyl cyanide compound. The core may have an average particle diameter of about 1,000 Å to about 4,000 Å.

The graft copolymer (B) may include about 30 wt % to about 60 wt % of the core and about 40 wt % to about 70 wt % of the shell, based on the total amount (weight) of the graft copolymer.

The shell may include about 50 wt % to about 80 wt % of the repeating unit derived from the aromatic vinyl compound and about 20 wt % to about 50 wt % of the repeating unit derived from the vinyl cyanide compound, based on the total amount of the shell.

The copolymer (C) of an aromatic vinyl compound and a vinyl cyanide compound may have a weight average molecular weight (Mw) of about 50,000 g/mol to about 150,000 g/mol.

The thermoplastic resin composition may include about 30 wt % to about 50 wt % of the polycarbonate resin (A); about 10 wt % to about 30 wt % of the graft copolymer (B) including an aromatic vinyl compound and a vinyl cyanide compound grafted on a conjugated diene-based rubbery polymer; and about 20 wt % to about 60 wt % of the copolymer (C) of an aromatic vinyl compound and a vinyl cyanide compound, based on the total amount (weight) of the thermoplastic resin composition.

The thermoplastic resin composition may further include one or more additives, such as a dye, a pigment, a flame retardant, a filler, stabilizer, a lubricant, an antibacterial agent, a release agent, or a combination thereof.

According to another embodiment, a molded product prepared using the thermoplastic resin composition is provided.

The molded product may have a plating adhesion of greater than or equal to about 650 g/cm.

The thermoplastic resin composition may provide excellent etching properties and plating adhesion.

### BRIEF DESCRIPTION OF THE DRAWINGS

FIG. 1 is a SEM photograph of the specimen according to Example 2 after applying an etchant thereto.

FIG. 2 is a SEM photograph of the specimen according to Comparative Example 1 after applying an etchant thereto.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” refers to one substituted with at least one substituent including halogen (—F, —Cl, —Br or —I), a hydroxy group, a nitro group, a cyano group, an amino group, an azido group, an amidino group, a hydrazine group, a hydrazone group, a carbonyl group, a carbamyl group, a thiol group, an ester group, a carboxyl group or a salt thereof, a sulfonic acid group or a salt thereof, a phosphoric acid group or a salt thereof, C1 to C20 alkyl, C2 to C20 alkenyl, C2 to C20 alkynyl, C1 to C20 alkoxy, C6 to C30 aryl, C6 to C30 aryloxy, C3 to C30 cycloalkyl, C3 to C30 cycloalkenyl, C3 to C30 cycloalkynyl, or a combination thereof, instead of at least one hydrogen of a functional group.

A thermoplastic resin composition according to one embodiment includes (A) a polycarbonate resin; (B) a graft copolymer including an aromatic vinyl compound and a vinyl cyanide compound grafted on a conjugated diene-based rubbery polymer; and (C) a copolymer of an aromatic vinyl compound and a vinyl cyanide compound. The copolymer (C) of an aromatic vinyl compound and a vinyl cyanide compound may include a repeating unit derived from the vinyl cyanide compound in an amount of about 18 wt % to about 22 wt %, based on the total amount (weight) of the copolymer (C).

The thermoplastic resin composition may provide excellent etching properties and excellent plating adhesion by including the polycarbonate resin (A); the graft copolymer (B); and the copolymer (C) including a repeating unit derived from the vinyl cyanide compound in an amount of about 18 wt % to about 22 wt %. Accordingly, the thermoplastic resin composition may be useful in applications including plating, for example, a building material, an exterior material for an automobile or other vehicle, and the like.

Hereinafter, each component of the thermoplastic resin composition is described in detail.

(A) Polycarbonate (PC) Resin

A polycarbonate resin may provide properties such as impact resistance, heat resistance, flexural properties, tensile properties, and the like to a thermoplastic resin composition.

The polycarbonate resin may be prepared by reacting one or more diphenols with a compound of phosgene, halogen formate, carbonate ester, or a combination thereof.

Examples of the diphenols may include without limitation hydroquinone, resorcinol, 4,4′-dihydroxydiphenyl, 2,2-bis(4-hydroxyphenyl)propane (referred to as “bisphenol-A”), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In one embodiment, 2,2-bis(4-hydroxyphenyl)-propane, 2,2-bis(3,5-dichloro-4-hydroxyphenyl)-propane, and/or 1,1-bis(4-hydroxyphenyl)-cyclohexane of the diphenols may be used, and in another embodiment, 2,2-bis(4-hydroxyphenyl)propane may be used.

The polycarbonate resin may be a mixture of two or more polycarbonate resins obtained using two or more diphenols that are different from each other. The polycarbonate resin may also include a linear polycarbonate resin, a branched polycarbonate resin, a polyester carbonate copolymer, or a combination thereof.

The linear polycarbonate resin may include a bisphenol-A based polycarbonate resin.

The branched polycarbonate resin may include one produced by reacting a multi-functional aromatic compound such as trimellitic anhydride, trimellitic acid, and the like with one or more diphenols and a carbonate. A repeating unit derived from the multi-functional aromatic compound may be included in an amount of about 0.05 to about 2 mol % based on the total weight of repeating units of the polycarbonate resin.

The polyester carbonate copolymer resin may include one produced by reacting a difunctional carboxylic acid with one or more diphenols and a carbonate. The carbonate may include a diaryl carbonate such as diphenyl carbonate and ethylene carbonate.

The polycarbonate resin may have a weight average molecular weight (Mw) of about 10,000 g/mol to about 50,000 g/mol. When the polycarbonate resin has a weight average molecular weight within the above range, excellent impact resistance and heat resistance may be realized. In one embodiment, the polycarbonate resin may have a weight average molecular weight (Mw) of about 15,000 g/mol to about 30,000 g/mol.

The thermoplastic resin composition may include the polycarbonate resin (A) in an amount of about 30 wt % to about 50 wt %, for example about 40 wt % to about 50 wt %, based on the total amount (weight) of the thermoplastic resin composition. In some embodiments, the thermoplastic resin composition may include the polycarbonate resin in an amount of about 30, 31, 32, 33, 34, 35, 36, 37, 38, 39, 40, 41, 42, 43, 44, 45, 46, 47, 48, 48, or 50 wt %. Further, according to some embodiments of the present invention, the amount of polycarbonate resin can be in a range from about any of the foregoing amounts to about any other of the foregoing amounts.

When the polycarbonate resin (A) is included within in an amount within the above ranges, excellent impact resistance and heat resistance may be realized.

(B) Graft Copolymer Including an Aromatic Vinyl Compound and a Vinyl Cyanide Compound Grafted on a Conjugated Diene-Based Rubbery Polymer

The graft copolymer is prepared by graft-polymerizing an aromatic vinyl compound and a vinyl cyanide compound into a conjugated diene-based rubbery polymer. The graft copolymer may reinforce impact resistance and also may play a role of increasing plating adhesion, since it can be effectively etched during the plating process.

Examples of the conjugated diene-based rubbery polymer may include without limitation butadiene rubbery polymers, isoprene rubbery polymers, chloroisoprene rubbery polymers, and the like, and combinations thereof. The conjugated diene-based rubbery polymer can have a high graft ratio and can provide excellent impact strength to a final graft copolymer.

Examples of the aromatic vinyl compound may include without limitation styrene, C1 to C10 alkyl substituted styrenes, halogen substituted styrenes, vinyl toluene, vinyl naphthalene, and the like, and combinations thereof. Examples of the alkyl substituted styrene may include without limitation o-ethyl styrene, m-ethyl styrene, p-ethyl styrene, α-methyl styrene, and the like, and combinations thereof.

Examples of the vinyl cyanide compound may include without limitation acrylonitrile, methylacrylonitrile, ethylacrylonitrile, and the like, and combinations thereof.

An exemplary graft copolymer (B) may include an ABS resin prepared by grafting styrene and acrylonitrile into a butadiene rubbery polymer. The ABS resin may be used singularly or as a mixture of two or more resins.

The graft copolymer (B) may have a core-shell structure including the conjugated diene-based rubbery polymer as a core and the aromatic vinyl compound and the vinyl cyanide compound graft-polymerized into the core and forming a shell.

The core including the conjugated diene-based rubbery polymer may have a structure including a single layer, a bilayer, or a combination thereof depending on a desired property.

According to one embodiment, the core may a single-layered rubber core including the conjugated diene-based rubbery polymer.

According to another embodiment, the core may be a bilayer rubber core having an inner layer including the conjugated diene-based rubbery polymer and a repeating unit derived from the aromatic vinyl compound and an outer layer including the conjugated diene-based rubbery polymer. The bilayer rubber core may further effectively improve impact resistance.

The core may have an average particle diameter of about 1,000 Å to about 4,000 Å, for example about 1,000 Å to about 3,000 Å, and in another example about 1,300 Å to about 2,500 Å. When the core has an average particle diameter within the above range, the composition may provide excellent impact resistance and effectively increase plating adhesion as well as an etched part is not observed with bare eyes during the plating process.

The graft copolymer (B) may include about 30 wt % to about 60 wt % of the core and about 40 wt % to about 70 wt % of the shell, based on the total amount (weight) of the graft copolymer. In one embodiment, the graft copolymer (B) may include about 45 wt % to about 60 wt % of the core and about 40 wt % to about 55 wt % of the shell, based on the total amount of the graft copolymer.

In some embodiments, the graft copolymer (B) may include the core in an amount of about 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, or 60 wt %. Further, according to some embodiments of the present invention, the amount of core can be in a range from about any of the foregoing amounts to about any other of the foregoing amounts.

In some embodiments, the graft copolymer (B) may include the shell in an amount of about 40, 41, 42, 43, 44, 45, 46, 47, 48, 48, 50, 51, 52, 53, 54, 55, 56, 57, 58, 59, 60, 61, 62, 63, 64, 65, 66, 67, 68, 69, or 70 wt %. Further, according to some embodiments of the present invention, the amount of shell can be in a range from about any of the foregoing amounts to about any other of the foregoing amounts.

When the graft copolymer (B) includes the core and the shell in an amount within the above range, the composition may have high polymerization stability and be effectively dispersed in a matrix.

The shell may include a repeating unit derived from the aromatic vinyl compound in an amount ranging from about 50 wt % to about 80 wt % and a repeating unit derived from the vinyl cyanide compound in an amount ranging from about 20 wt % to about 50 wt % based on the total amount (weight) of the shell. In one embodiment, the shell may include a repeating unit derived from the aromatic vinyl compound in an amount ranging from about 60 wt % to about 80 wt % and a repeating unit derived from the vinyl cyanide compound in an amount ranging from about 20 wt % to about 40 wt % based on the total amount of the shell.

In some embodiments, the shell may include a repeating unit derived from the aromatic vinyl compound in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the repeating unit derived from the aromatic vinyl compound can be in a range from about any of the foregoing amounts to about any other of the foregoing amounts.

In some embodiments, the shell may include a repeating unit derived from the vinyl cyanide compound in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, or 50 wt %. Further, according to some embodiments of the present invention, the amount of the repeating unit derived from the vinyl cyanide compound can be in a range from about any of the foregoing amounts to about any other of the foregoing amounts.

When the shell includes the repeating units derived from the aromatic vinyl compound and the vinyl cyanide compound in amounts within the above ranges, the composition may be effectively dispersed in a matrix.

On the other hand, the graft copolymer may include the aromatic vinyl compound in an amount ranging from about 30 parts by weight to about 60 parts by weight and the vinyl cyanide compound in an amount ranging from about 10 parts by weight to about 30 parts by weight grafted into about 100 parts by weight of the conjugated diene-based rubbery polymer.

In some embodiments, the graft copolymer may include the aromatic vinyl compound in an amount of about 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, or 60 parts by weight. Further, according to some embodiments of the present invention, the amount of the aromatic vinyl compound can be in a range from about any of the foregoing amounts to about any other of the foregoing amounts.

In some embodiments, the graft copolymer may include the vinyl cyanide compound in an amount of about 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the vinyl cyanide compound can be in a range from about any of the foregoing amounts to about any other of the foregoing amounts.

The graft copolymer may have a high graft rate and optimal properties including impact resistance. In one embodiment, the graft copolymer may include the aromatic vinyl compound in an amount ranging from about 30 parts by weight to about 40 parts by weight and the vinyl cyanide compound in an amount ranging from about 10 parts by weight to about 20 parts by weight grafted into about 100 parts by weight of the conjugated diene-based rubbery polymer.

The thermoplastic resin composition may include about 10 wt % to about 30 wt %, for example about 20 wt % to about 30 wt %, of the graft copolymer (B) including an aromatic vinyl compound and a vinyl cyanide compound grafted on a conjugated diene-based rubbery polymer, based on the total amount (weight) of the thermoplastic resin composition. In some embodiments, the thermoplastic resin composition may include the graft copolymer (B) in an amount of about 10, 11, 12, 13, 14, 15, 16, 17, 18, 19, 20, 21, 22, 23, 24, 25, 26, 27, 28, 29, or 30 wt %. Further, according to some embodiments of the present invention, the amount of graft copolymer (B) can be in a range from about any of the foregoing amounts to about any other of the foregoing amounts.

When the thermoplastic resin composition includes the graft copolymer (B) in an amount within the above range, the composition may be effectively etched during the plating process and may effectively improved plating adhesion. The graft copolymer (B) may be prepared by emulsion polymerization, suspension polymerization, solution polymerization, massive polymerization, or a combination thereof, without limitation.

(C) Copolymer of an Aromatic Vinyl Compound and a Vinyl Cyanide Compound

The copolymer (C) is prepared by polymerizing an aromatic vinyl compound and a vinyl cyanide compound and may play a role of a matrix and dispersing the graft copolymer (B).

Hereinafter, the aromatic vinyl compound and the vinyl cyanide compound are the same as aforementioned unless specifically illustrated.

The copolymer (C) may include a styrene-acrylonitrile (SAN) resin prepared by copolymerizing styrene and acrylonitrile. The SAN resin may be included as a single kind or as a mixture of two or more kinds but is not limited thereto.

The copolymer (C) may include a repeating unit derived from the vinyl cyanide compound in an amount of about 18 wt % to about 22 wt % based on the total amount of the copolymer (C). In some embodiments, the copolymer (C) may include a repeating unit derived from the vinyl cyanide compound in an amount of about 18, 19, 20, 21, or 22 wt %. Further, according to some embodiments of the present invention, the amount of the repeating unit derived from the vinyl cyanide compound can be in a range from about any of the foregoing amounts to about any other of the foregoing amounts.

When the copolymer (C) includes a repeating unit derived from the vinyl cyanide compound in an amount within the above range, excellent etching properties and plating adhesion may be effectively accomplished, and a graft copolymer (B) may be effectively dispersed.

The copolymer (C) of an aromatic vinyl compound and a vinyl cyanide compound may have a weight average molecular weight (Mw) of about 50,000 g/mol to about 150,000 g/mol. When the (C) copolymer has a weight average molecular weight (Mw) within the above range, excellent formability and impact resistance may be improved. In one embodiment, the copolymer (C) of an aromatic vinyl compound and a vinyl cyanide compound may have a weight average molecular weight (Mw) of about 80,000 g/mol to about 120,000 g/mol.

The thermoplastic resin composition may include the copolymer (C) of an aromatic vinyl compound and a vinyl cyanide compound in an amount of about 20 wt % to about 60 wt %, for example about 20 wt % to about 40 wt %, based on the total amount (weight) of the thermoplastic resin composition. In some embodiments, the thermoplastic resin composition may include the copolymer (C) in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, or 60 wt %. Further, according to some embodiments of the present invention, the amount of copolymer (C) can be in a range from about any of the foregoing amounts to about any other of the foregoing amounts.

When the thermoplastic resin composition includes the copolymer (C) in an amount within the above range, the copolymer (C) may effectively act as a matrix in which the graft copolymer (B) may be dispersed

(D) Other Additive(s)

One or more other additives (D) may be included in the thermoplastic resin composition. The additives can be used to provide various properties, such as injection molding property, property balance, and the like.

Examples of the additives include without limitation dyes, pigments, flame retardants, filler, stabilizers, lubricants, antibacterial agents, release agents, and the like, and combinations thereof.

The additive (D) may be included in an amount appropriate for a particular use and/or to impart a particular property, as long as properties of the thermoplastic resin composition are not significantly deteriorated. Generally the thermoplastic resin composition can include the additive in an amount ranging from less than or equal to about 40 parts by weight, for example from about 0.1 parts by weight to about 30 parts by weight, based on about 100 parts by weight of the graft copolymer (B).

Hereinbefore, exemplary amounts and types of the components described herein included in the thermoplastic resin composition are illustrated but the skilled artisan will appreciate that the amounts and types of the composition components may be appropriately adjusted depending on the intrinsic characteristics of each component and depending on the desired properties of a final thermoplastic resin composition.

A thermoplastic resin composition according to one embodiment may be prepared using any well-known method of preparing a resin composition. For example, each component according to one embodiment can be simultaneously mixed optionally with one or more additives. The mixture can be melt-extruded and prepared in pellet form.

According to another embodiment, the aforementioned thermoplastic resin composition is molded to provide a molded product. The molded product can have excellent etching properties, plating adhesion, mechanical properties, thermal characteristic, and formability and thus, may be manufactured into various sizes and structures in various fields. For example, the molded product may be an exterior material for a vehicle such as an automobile.

The molded product may have plating adhesion of greater than or equal to about 650 g/cm, for example about 650 g/cm to about 1,000 g/cm. When the molded product has a plating adhesion within the above range, the molded product may have effective plating thereon and detachment of a plated part may be effectively minimized or prevented and suppressed during the plating process.

### EXAMPLES

The following examples illustrate this disclosure in more detail. However, it is understood that this disclosure is not limited by these examples.

A thermoplastic resin composition includes each component as follows.

(A) Polycarbonate resin

(A-1) Polycarbonate resin: a weight average molecular weight (Mw) of 27,000 g/, available from Cheil Industries Inc.

(A-2) Polycarbonate resin: a weight average molecular weight (Mw) of 22,000 g/mol, available from Cheil Industries Inc.

(B) Graft copolymer including an aromatic vinyl compound and a vinyl cyanide compound grafted on a conjugated diene-based rubbery polymer

Acrylonitrile-butadiene-styrene copolymer: core content: 58 wt %, shell content: 42 wt %, content of core components: butadiene of 100 wt %, content of shell components: 75 wt % of styrene and 25 wt % of acrylonitrile, available from Cheil Industries Inc.

(C) Copolymer of an aromatic vinyl compound and a vinyl cyanide compound

(C-1) An acrylonitrile-styrene copolymer: acrylonitrile content: 33 wt %, styrene content: 67 wt %, a weight average molecular weight of 90,000 g/mol, available from Cheil Industries Inc.

(C-2) An acrylonitrile-styrene copolymer: acrylonitrile content: 23 wt %, styrene content: 77 wt %, a weight average molecular weight of 90,000 g/mol, available from Cheil Industries Inc.

(C-3) An acrylonitrile-styrene copolymer: acrylonitrile content: 27 wt %, styrene content: 73 wt %, a weight average molecular weight of 90,000 g/mol, available from Cheil Industries Inc.

(C-4) An acrylonitrile-styrene copolymer: acrylonitrile content: 20 wt %, styrene content: 80 wt %, a weight average molecular weight of 90,000 g/mol available from Cheil Industries Inc.

(C-5) An acrylonitrile-styrene copolymer: acrylonitrile content: 15 wt %, styrene content: 85 wt %, a weight average molecular weight of 90,000 g/mol, available from Cheil Industries Inc.

### Examples 1 to 6 and Comparative Examples 1 to 4

### Preparation of Thermoplastic Resin Composition

Each thermoplastic resin composition according to Examples 1 to 6 and Comparative Examples 1 to 4 is prepared using the aforementioned components in the amounts provided in the following Table 1.

The components are mixed to have the composition in the following Table 1. Then, the mixtures are respectively placed in a twin-screw extruder having L/D=29 and φ=45 mm after setting a barrel temperature to about 250° C. The mixtures are extruded to form resin composition pellets.

TABLE 1

| | | | Examples | | | | | | Comparative Examples | | | |
|---|---|---|---|---|---|---|---|---|---|---|---|---|
| | | | 1 | 2 | 3 | 4 | 5 | 6 | 1 | 2 | 3 | 4 |
| (A) | A-1 | wt % | 31 | 31 | 31 | 31 | 31 | 31 | 31 | 31 | 31 | 31 |

| | | | | | | | | | | |
|---|---|---|---|---|---|---|---|---|---|---|
| A-2 | 15 | 15 | 15 | 15 | 15 | 15 | 15 | 15 | 15 | 15 |

| | | | | | | | | | | |
|---|---|---|---|---|---|---|---|---|---|---|
| (B) | 25 | 25 | 25 | 25 | 25 | 25 | 25 | 25 | 25 | 25 |

| | | | | | | | | | | | |
|---|---|---|---|---|---|---|---|---|---|---|---|
| (C) | C-1 | — | — | — | — | — | — | — | — | — | 29 |
| | C-2 | — | — | 5 | 10 | 15 | 19 | — | — | 29 | — |
| | C-3 | — | — | — | — | — | — | — | 29 | — | — |
| | C-4 | 19 | 29 | 24 | 19 | 14 | 10 | — | — | — | — |
| | C-5 | 10 | — | — | — | — | — | 29 | — | — | — |

| | | | | | | | | | | |
|---|---|---|---|---|---|---|---|---|---|---|
| Content of | 18.3 | 20.0 | 20.5 | 21.0 | 21.6 | 22.0 | 15.0 | 27.0 | 23.0 | 33.0 |
| acrylonitrile in (C) | | | | | | | | | | |
| (wt %) | | | | | | | | | | |

### Experimental Example 1

### Plating Adhesion

The thermoplastic resin compositions according to Examples 1 to 6 and Comparative Examples 1 to 4 are dried at about 100° C. for about 2 hours and then injection-molded into ASTM specimens by setting a cylinder temperature of about 260° C., a molding temperature of about 60° C., and a molding cycle of about 30 seconds using a 6 oz injection molding machine

The specimens (152.4 mm×152.4 mm×3 mm) are respectively plated. The plating process is as follows.

First of all, the specimens are treated using a surfactant at about 55° C. for about 5 minutes to remove oil and to oxidize butadiene at about 65° C. for about 15 minutes using anhydrous chromic acid/sulfuric acid (a volume ratio=370/430) as an etching agent.

Then, the resulting product is treated using a hydrochloric acid aqueous solution at about 25° C. for about 25 seconds to remove remaining chromic acid and using a palladium-tin (Pd/Sn) catalyst at about 30° C. for about 2 minutes to adsorb anchor holes of palladium. Next, it is activated at about 55° C. for about 2 minutes to remove tin using an aqueous sulfuric acid solution and then, electroless plated at about 30° C. for about 5 minutes using nickel sulfate.

Then, the resulting product is electroplated using copper, nickel, and chromium. In particular, it is copper-electroplated at about 25° C. for about 35 minutes with about 3 Å/dm² using copper sulfate. The nickel-electroplating is performed using nickel sulfate at about 55° C. for about 15 minutes with about 3 Å/d m². The chromium-electroplating is performed using anhydrous chromic acid at about 55° C. for about 3 minutes with about 15 Å/dm². The plating layer may include a copper plating layer having a thickness ranging from about 25 to about 27 μm, a nickel plating layer having a thickness ranging from about 10 to about 11 μm, and a chromium plating layer having a thickness ranging from about 0.4 to about 0.5 μm and thus, have a thickness ranging from about 36 to about 38 μm in total.

The specimens are evaluated for plating adhesion by making an about 10 mm-wide cut on the plated surface and peeling off about 80 mm in a vertical direction using a pull gauge in order to obtain strength, reported as a g/cm unit. The evaluation is repeated three times, and the average thereof is calculated. The results are provided in the following Table 2.

### Experimental Example 2

### Etching Properties

A SEM photograph of the appearance of each specimen is taken after oxidizing butadiene with an etchant in Experimental Example 1. Herein, a field emission gun scanning electron microscope (FEG-SEM) JSM-6390 (JEOL Ltd.) is used.

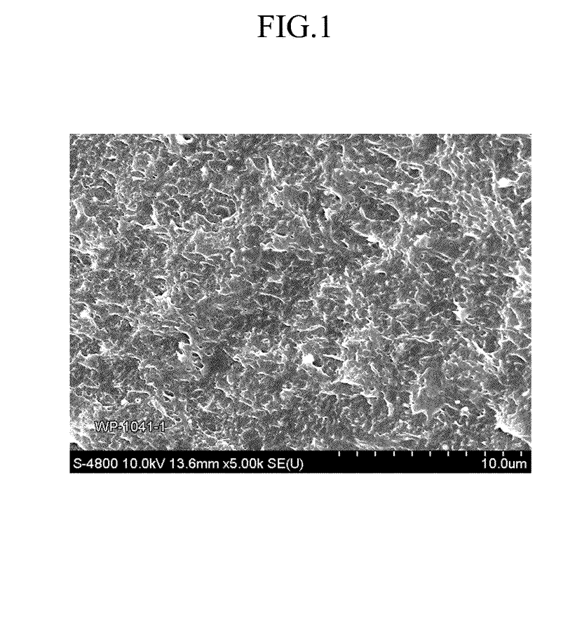

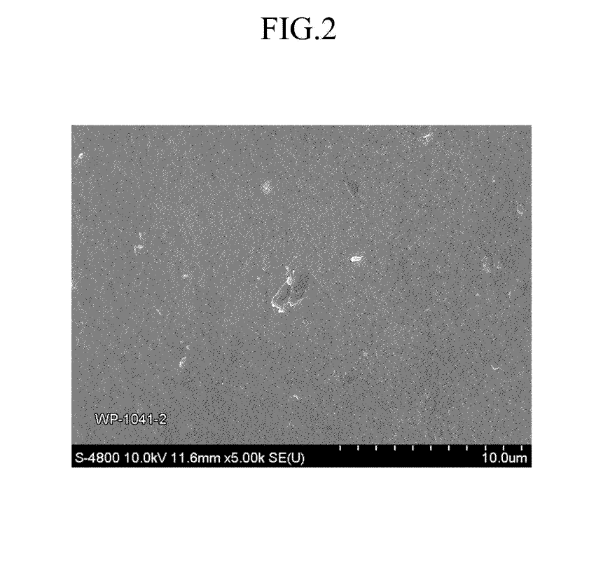

FIG. 1 is the SEM photograph of Example 2, and FIG. 2 is the SEM photograph of Comparative Example 1. With reference to the SEM photographs, each thermoplastic resin composition is evaluated regarding etching properties.

The results are provided in the following Table 2.

<Etching Properties Evaluation Reference>

Good: etching property corresponding to FIG. 1

Inferior: etching property corresponding to FIG. 2

TABLE 2

| | Example | | | | | | Comparative Example | | | |
|---|---|---|---|---|---|---|---|---|---|---|
| | 1 | 2 | 3 | 4 | 5 | 6 | 1 | 2 | 3 | 4 |
| Plating adhesion | 890 | 830 | 820 | 760 | 750 | 690 | 1080 | 350 | 550 | 300 |
| (g/cm) | | | | | | | | | | |
| Etching properties | good | good | good | good | good | good | inferior | good | good | good |

Referring to Table 2, the thermoplastic resin compositions according to Examples 1 to 6 have excellent plating adhesion and etching properties.

On other hand, the thermoplastic resin composition according to Comparative Example 1 has excellent plating adhesion but inferior etching properties. The thermoplastic resin compositions according to Comparative Examples 2 to 4 have good etching properties but inferior plating adhesion.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition, comprising
(A) a polycarbonate resin;
(B) a graft copolymer including an aromatic vinyl compound and a vinyl cyanide compound grafted on a conjugated diene-based rubbery polymer; and
(C) a copolymer of an aromatic vinyl compound and a vinyl cyanide compound,
wherein the copolymer (C) of an aromatic vinyl compound and a vinyl cyanide compound comprises a repeating unit derived from the vinyl cyanide compound in an amount of about 18 wt % to about 22 wt %, based on the total weight of the copolymer (C).

2. The thermoplastic resin composition of claim 1, wherein the polycarbonate resin (A) has a weight average molecular weight (Mw) of about 10,000 g/mol to about 50,000 g/mol.

3. The thermoplastic resin composition of claim 1, wherein the conjugated diene-based rubbery polymer comprises a butadiene rubbery polymer, an isoprene rubbery polymer, a chloroisoprene rubbery polymer, or a combination thereof.

4. The thermoplastic resin composition of claim 1, wherein the aromatic vinyl compound comprises styrene, C1 to C10 alkyl substituted styrene, halogen substituted styrene, vinyl toluene, vinyl naphthalene, or a combination thereof.

5. The thermoplastic resin composition of claim 1, wherein the vinyl cyanide compound comprises acrylonitrile, methylacrylonitrile, ethylacrylonitrile, or a combination thereof.

6. The thermoplastic resin composition of claim 1, wherein the graft copolymer (B) comprises a core including the conjugated diene-based rubbery polymer and a shell including a repeating unit derived from the aromatic vinyl compound and the repeating unit derived from the vinyl cyanide compound.

7. The thermoplastic resin composition of claim 6, wherein the core has an average particle diameter of about 1,000 Å to about 4,000 Å.

8. The thermoplastic resin composition of claim 6, wherein the graft copolymer (B) comprises about 30 wt % to about 60 wt % of the core and about 40 wt % to about 70 wt % of the shell, based on the total weight of the graft copolymer.

9. The thermoplastic resin composition of claim 6, wherein the shell comprises about 50 wt % to about 80 wt % of the repeating unit derived from the aromatic vinyl compound and about 20 wt % to about 50 wt % of the repeating unit derived from the vinyl cyanide compound, based on the total weight of the shell.

10. The thermoplastic resin composition of claim 1, wherein the copolymer (C) of an aromatic vinyl compound and a vinyl cyanide compound has a weight average molecular weight (Mw) of about 50,000 g/mol to about 150,000 g/mol.

11. The thermoplastic resin composition of claim 1, wherein the thermoplastic resin composition comprises about 30 wt % to about 50 wt % of the polycarbonate resin (A); about 10 wt % to about 30 wt % of the graft copolymer (B) including an aromatic vinyl compound and a vinyl cyanide compound grafted on a conjugated diene-based rubbery polymer; and about 20 wt % to about 60 wt % of the copolymer (C) of an aromatic vinyl compound and a vinyl cyanide compound, based on the total weight of the thermoplastic resin composition.

12. The thermoplastic resin composition of claim 1, wherein the thermoplastic resin composition further comprises a dye, a pigment, a flame retardant, a filler, stabilizer, a lubricant, an antibacterial agent, a release agent, or a combination thereof.

13. A molded product prepared using the thermoplastic resin composition of claim 1.

14. The molded product of claim 13, wherein the molded product has a plating adhesion of greater than or equal to about 650 g/cm.

15. The molded product of claim 14, wherein the molded product has a plating adhesion of about 650 g/cm to about 1,000 g/cm.
